(19) United States
(12) Patent Application Publication
(10) Pub. No.: US 2005/0239661 A1
(43) Pub. Date: Oct. 27, 2005

(54) Downhole catalytic combustion for hydrogen generation and heavy oil mobility enhancement

(76) Inventor: William C. Pfefferle, Madison, CT (US)

Correspondence Address: Robert L. Rispoli;Precision Combustion, Inc., 410 Sackett Point Road, North Haven, CT, 06473, US

(21) Appl. No.: 11/101,034

(22) Filed: Apr. 6, 2005

Related U.S. Application Data
(60) Provisional application No. 60/564,077, filed on Apr. 21, 2004.

(51) Int. Cl. C09K 7/02

(52) U.S. Cl. 507/100

(57) ABSTRACT

A new concept for enhancing the mobility of crude oils is provided which enables efficient and effective recovery of heavy oils not presently accessible using existing techniques while concurrently yielding upgraded oils from the extracted heavy oils. The heavy oil that remains inaccessible after primary and secondary recovery operations, and the significant amounts of heavy oils that reside at depths below those accessible with conventional steam flooding operations, are made accessible.

### CROSS-REFERENCE

This application claims the benefit of U.S. Provisional Application No. 60/564,077 filed Apr. 21, 2004.

### FIELD OF THE INVENTION

The present invention is generally directed to a method and apparatus for enhancing the mobility of crude oils. More particularly, this invention enables efficient and effective recovery of heavy oils not presently accessible using existing techniques. The present invention also concurrently yields upgraded oils from the extracted heavy oils. In sum, the heavy oil that remains inaccessible after primary and secondary recovery operations, and the significant amounts of heavy oils that reside at depths below those accessible with conventional steam flooding operations such as employed in California and Alberta fields, are made accessible with the present invention.

### BACKGROUND OF THE INVENTION

Heavy oils represent by far the larger portion of the world's oil in place, yet represent only a minor portion of world oil production. With the normal yearly decrease in production from existing wells, production level can only be maintained by opening up new fields. Although the world is in no danger of soon running out of oil, it has become increasingly difficult to find new conventional oil fields. Thus it is recognized that at some time in the not too distant future, production of conventional crude oils will peak and thereafter decrease in spite of continuing new discoveries. Fortunately, large deposits of heavy and ultra-heavy oils exist and production is expanding. However, upgrading is required if the oil is to be processed in conventional refineries. A significant issue is that most heavy oils cannot be transported by pipeline, as to a nearby upgrading facility, without dilution with a light oil. A longer term issue is that the bulk of heavy oil reserves occur at depths greater than about 1500-2000 feet, yet existing steam flooding extraction methods have proven useful only at lesser depths. Technology is needed not only to produce an upgraded oil, but also to reduce heat losses sufficiently to allow economic extraction of currently inaccessible deposits, effectively increasing oil reserves.

Steam flooding from surface steam generators is an effective and broadly-applicable thermal recovery approach to enhanced oil recovery. The primary effects are reducing oil viscosity enough to allow the oil to flow toward a production wellhead. The oil removed tends to be the more mobile fraction of the reservoir. Further, the combustion emissions of the steam generator can be limiting (as in California). Such steam flooding faces limiting technical and economic obstacles relating not only to conductive heat losses through the wellbore but also to incomplete reservoir sweep efficiency, especially in heterogeneous reservoirs. With ultra-heavy oils there is a further problem. Even if such an oil is heated sufficiently to permit it to flow to a wellhead, heat loss in flowing to the surface from typical depths can result in loss of fluidity of the heavy oil before reaching the surface. Accordingly, well bore heating could be needed to prevent well plugging. In addition, the produced oil typically cannot be pipelined to an upgrading plant without dilution with a suitable solvent oil. This significantly increases transportation cost. Thus there is a need to produce oil of sufficient fluidity for pipeline transport.

To overcome the wellbore heat loss problems involved in surface steam generation, there has been work on producing the steam downhole. Sandia Laboratories under the U.S. Department of Energy (“DOE”) sponsorship operated a downhole direct combustion steam generator (Project Deepsteam) burning natural gas and diesel at Long Beach, Calif. in the Wilmington field. Although there were initial problems relating to steam infectivity into the reservoir, results demonstrated the advantages in terms of reduced heat losses. However, the Project Deepsteam approach exhibits problems with soot formation in rich operation or in stoichiometric operation. In a more advanced approach, in the 1980's Dresser Industries developed a catalytic downhole steam generator burning oil-water emulsions (U.S. Pat. Nos. 4,687,491 and 4,950,454). Although, this approach eliminates soot formation and reduces heat loss in supplying steam to a formation, the heated oil heat loss in the production well is still impacts production rates. Thus the depth from which heavy oil can be extracted is still limited and surface transport is still a problem.

Accordingly there have been efforts to employ in-situ viscbreaking to reduce heavy oil viscosity by hydrotreating the oil. This approach has been studied in another DOE-funded program carried out by the National Institute for Petroleum and Energy Research. While these results were disappointing for the stated objective of high hydrogen uptake, detailed analysis of the data supports the concept of extensive viscbreaking at a sufficiently long reaction time, even with minimal hydrogen usage. The results of surface reactor testing, as reported to the DOE, show that despite little evidence of aromatic saturation, substantial viscbreaking was achieved. Hydrotreating in the presence of a catalyst resulted in a 50 percent reduction in molecular weight of the oil with a reduction in viscosity at 130 F from 2955 centiStokes (“cSt”) to 33.1 cSt. This compares to a 27 percent reduction in molecular weight and a resulting viscosity of 90.5 for hydrogenation in the absence of catalyst. These results demonstrate significant viscosity reduction even for non-catalytic hydrotreating. It should be noted that viscbreaking and hydrotreating are well-established refinery processes and process conditions are well known in the art. In comparing non-catalytic hydrogenation with thermal viscbreaking, oil recovery increased from 62.3 percent to 98 percent. Unfortunately, there has been no economically feasible way to supply hydrogen and the heat necessary to accomplish hydrotreating in-situ. One attempt involves producing hydrogen at the surface for injection downhole with combustion of a portion of the hydrogen for heat generation. Such an approach involves high costs and significant energy losses. Since hydrogen must be produced from fossil fuel on the surface, the nominal fifty percent energy loss in the conversion cannot be used to heat the reservoir. Accordingly, hydrogen must be burned downhole to heat the formation to a suitable reaction temperature. A further issue is the need to actually heat the oil to the required reaction temperature. Merely injecting heated fluids may not resolve this because even modest heating increases oil mobility and can result in movement of the oil away from the heat source. Therefore, any migration of oil must provide contact with a sufficiently heated zone. To date, no economically useful method to upgrade oil downhole has been demonstrated.

Thus there is a need for an efficient cost effective process for enhancing the mobility and recovery of oils not presently accessible using current extraction techniques. With worldwide consumption of petroleum increasing year-by-year, production of oil from heavy crude oil deposits in accordance with the present invention can play an important role in limiting dependence on importation of petroleum to meet consumption demand.

### SUMMARY OF THE INVENTION

It has now been found that a novel process based upon downhole fuel-rich combustion of a hydrocarbon fuel, combining downhole heat generation with the production of hydrogen, enables thermally efficient in-situ viscbreaking of heavy crude oils by hydrotreating. To assure that the oil is heated to the desired temperature, the hot hydrogen-rich gases are preferably introduced below the heavy oil deposit such that the oil which drains downward must pass through a heated region. In the process of the present invention, all heat released in the production of hydrogen is delivered to the reservoir. Thus all of the heating value of the fuel used for hydrogen production is available, whether as heat or as hydrogen. A catalyst may be injected into the oil bearing formation with the hydrogen, thus decreasing the required reaction time at temperature. Advantageously, at least a portion of the reservoir is maintained at a selected reaction temperature for at least several days, preferably at least five days to allow sufficient reaction time. A temperature of at least 600 F is preferred. Catalytic combustion is especially advantageous in the present invention permitting soot-free operation over a wide range of stoichiometries.

Crude oil viscosity is reduced both by heating the oil, as in steam flooding, and also by hydrotreating the oil thereby altering its chemical composition. Sweep efficiency is improved via enhancement of mobility and control of reservoir permeability as a result of the reduction of oil viscosity. The present invention comprises a downhole crude oil hydrogenation processing method which improves reservoir sweep efficiency and enhances quality of the crude oil delivered to the surface. Cost/barrel is consequently reduced. Moreover, this approach significantly increases available domestic oil reserves, and consequently decreases dependence on oil imports by making oil available from the abundant deposits of otherwise in-accessible heavy oils.

One preferred embodiment of the present invention comprises a superior and more flexible enhanced oil recovery process in which downhole generation of heat and hydrogen for in-situ hydroviscbreaking of oil deposits is generated by catalytic partial oxidation and/or autothermal reforming of a fuel, preferably using a precious metal catalyst. Any combustion catalyst known in the art may be used but platinum group metals are preferred for superior poison tolerance. Rhodium is a preferred catalyst having especially high selectivity for hydrogen production. The overall combustion stoichiometry is selected to provide the desired ratio of heat to hydrogen production and such stoichiometry may be varied accordingly. The hydrogen, carbon oxides and, if desired, steam are injected into an oil bearing formation to provide the heat and hydrogen necessary for hydrotreating the oil. Catalytic hydroviscbreaking/desulfurization of the oil reduces oil viscosity and disrupts oil-sand bonding. Very little hydrogen is required to rupture heterocyclic bonds within the large molecules typical of heavy crude thereby reducing crude molecular weight. This approach is in contrast to full hydrogenation for saturation of aromatics, which requires large amounts of hydrogen even without reducing molecular weight. In addition, the present invention achieves the beneficial features of CO2 miscible flooding, gaseous pressurization, and the ability to partially control breakthrough. Any partial oxidation or autothermal reformer system for hydrogen production that is known in the art may be used.

Downhole rich catalytic combustion of a hydrocarbon fuel, for example previously-extracted oil, whether or not suspended in a water emulsion, can be used to generate downhole steam and hydrogen for injection into tertiary and heavy oil reservoirs via autothermal reforming. Low cost catalytic materials advantageously may be added to the resultant high temperature effluent to hydroviscbreak the oil by mild catalytic hydrotreating. Fuel, water, air and catalyst/water solutions are transported downhole from the surface. The result is a process system which offers numerous benefits with a number of controllable variables. Because oil fields differ and the task of recovery varies in each case, these variables can be used to adapt the process to fit the particular reservoir conditions.

### BRIEF DESCRIPTION OF THE DRAWINGS

Oil upgrading in accordance with the present invention is illustrated in the drawings in which:

FIG. 1 is a cut-away isometric representation of an oil-bearing formation having a well into which a combustor may be placed for hydrogen production.

FIG. 2 is a schematic representation of the placement of a production well downstream from the injection well.

### DETAILED DESCRIPTION OF THE INVENTION

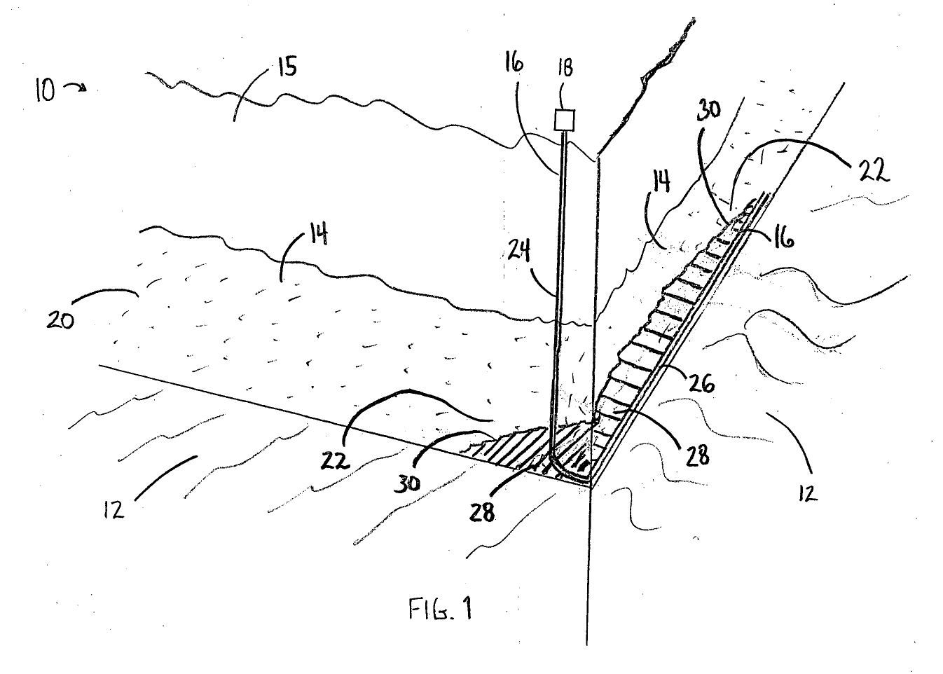

With reference to catalytic combustion system 10 of FIG. 1, low permeability layer 12 under lays oil-bearing sand deposit 14. Sand deposit 14 under lays overburden layer 15 which consists of shale, rock, permafrost, or the like. Sand deposit 14 defines an upslope region 20 and a downslope region 22. Well 16 extends downward from wellhead 18 on the surface and on nearing layer 12 turns and extends horizontally above layer 12 along downslope region 22 of sand deposit 14. A suitable combustor for hydrogen production (not shown) may be placed in either the vertical portion 24 or horizontal portion 26 of well 16. Hot hydrogen-containing fluid is injected into downslope region 22 of deposit 14 through the horizontal portion 26 of well 16 thereby forming hot fluid chest 28. Mobilized oil drains downslope from interface region 30 of hot fluid chest 28 with deposit 14 and collects around well 16 contained by layer 12 and downslope by cold immobile oil. After a desired amount of mobilized oil has collected and been held at temperature for a desired time, the collected oil may be recovered via the fluid injection well 16 in a technique known as huff-and-puff.

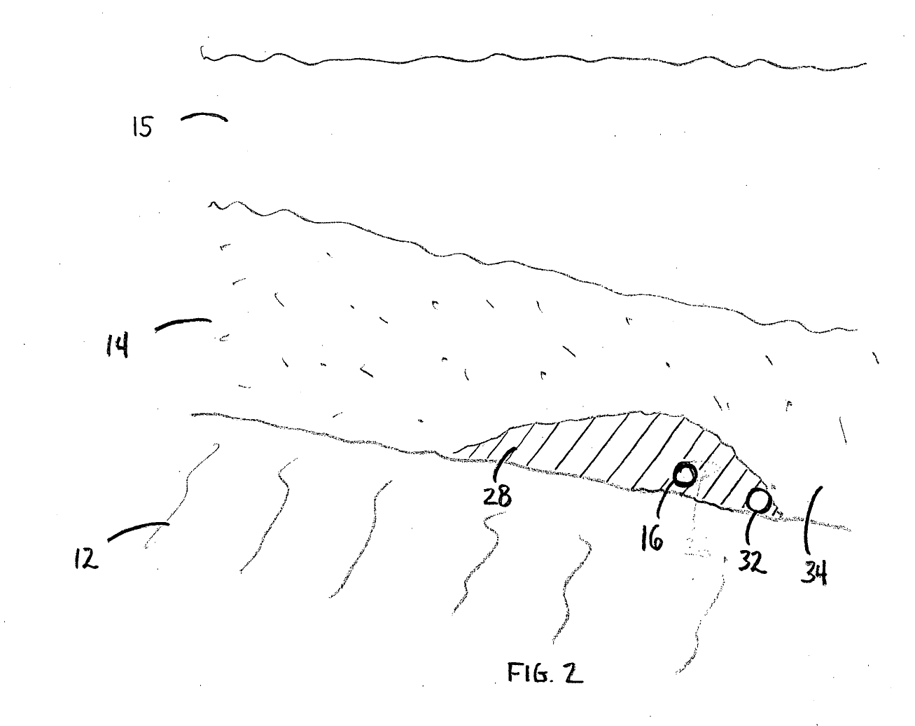

Alternatively, as shown in FIG. 2, the collected oil may be withdrawn through a production well 32 located downslope of well 16 along horizontal portion 26 and upslope of cold region 34 which acts as a seal to blocking further downstream flow of oil.

It is the catalytic combustor that makes downhole steam and hydrogen production feasible with a wide variety of hydrocarbon fuels. Gas or liquid fuels may be used. Although natural gas is a preferred fuel, catalytic combustion allows selective oxidation of even a heavy fuel without soot formation at the rich stoichiometries required for efficient production of hydrogen. Formation of soot could quickly clog a wellbore. During initial operation, hydrogen production may be sacrificed to allow maximum heat production for more rapid heating of the reservoir with hydrogen production and heat production balanced during subsequent operation. Conventional burners cannot combust the non-flammable oil emulsions which can be utilized in catalytic systems known in the art. Moreover, conventional flame burners cannot provide maximum yield of hydrogen. In one embodiment of the method of the present invention, a mixture comprising oxygen, a hydrocarbon fuel and steam is combusted in contact with a combustion catalyst suitable for selectivity to production of hydrogen, e.g. rhodium. Preferably, the steam to fuel ratio is sufficiently high to yield a product stream having a ratio of carbon monoxide to carbon dioxide of less than about 0.2, more preferably less than 0.1 to maximize hydrogen production. The heat necessary to vaporize water delivered downstream before passing into the catalyst as steam may be provided either by combustion of a fuel in an oxidant stream delivered downhole, or alternatively by recirculation of hot product gases. The water supplied downhole may be sprayed into the hot recirculated gases before or after admixing of the hot gases with the incoming combustion air.

In another embodiment of the present invention, hydrogen is produced by fuel rich partial oxidation of the fuel to produce a product stream comprising hydrogen and carbon monoxide. The temperature of the product stream may be reduced to a desired value by injection of water with the resultant production of steam. Optionally, the cooled product may be further reacted in the presence of a catalyst to produce additional hydrogen by water gas shift reaction of carbon monoxide with steam.

As in conventional steam flooding, heat and pressure are available as well as gravity to drive oil from the source and toward a producing well. Because viscbreaking reduces the oil molecular weight, the oil remains fluid even at low ambient temperatures. Thus, flow through the production well is no longer limited by heat loss during transport to the surface.

The catalytically assisted hydroviscbreaking of the oil in the reservoir will greatly reduce viscosity of the oil, while weakening molecular polarity thereby helping to displace the oil from the sand. Hydrotreating is widely used in petroleum refineries to upgrade oil quality. However, conventional fixed bed catalysts are not soluble in water or steam and therefore are unsuitable for injection into even a shallow depth oil-bearing formation. Water/steam miscible hydroviscbreaking catalysts include materials such as boria, potassium and sodium carbonate and the chlorides of metals such as chromium, cobalt, iron and nickel. The catalysts injected can be selected to adjust the pH of the steam. This can help control permeability of oil-bearing clays, the swelling of which is a function of pH. Inasmuch as catalytic elements are often present in underground strata, injection of added catalyst is not always required.

Hydroviscbreaking according to the present invention improves sweep efficiency of immobile deposits by improving fluidity through molecular weight reduction thereby increasing the mobile fraction of the reservoir. In addition, because hydrogenation is exothermic, heat is released which further increases oil fluidity. The resulting desulfirization improves the value of the oil.

Catalytic hydrotreating of heavy oils is a well-established technology in the petroleum refining industry for upgrading such oils and the required reaction conditions are well known in the art. In the present invention, temperatures of the art are available from a catalytic combustor. Advantageously, reaction a temperature of at least 600 F is preferred. A reaction temperature of 700 to 800 F or higher may be employed. Typical hydrogenation catalysts used include various base metal catalysts such as cobalt or nickel molybdate on an alumina support. Because conventional fixed bed catalysts are not soluble in water or steam, water-soluble catalysts are preferred in the present invention. Such catalysts can be mixed with water and injected into the hot hydrogen-rich steam-bearing effluent from a downhole combustor steam generator to produce catalyst-bearing hydrogen-rich steam of controlled temperature for injection into the oil-bearing strata. Water soluble, steam-volatile hydroviscbreaking catalysts include materials such as boria, potassium and sodium carbonate and the chlorides of metals such as chromium, cobalt, iron and nickel. Very long reaction times of three to five days or even weeks are available downhole compared to refinery applications which have reaction times in the order of minutes with throughputs of several pounds of oil per hour per pound of catalyst. Thus, even low activity hydrogenation catalysts may be used in the method of the present invention.

In the method of the present invention, CO2 and nitrogen in the exhaust from the catalytic combustor offers advantages related to CO2 flooding and pressure maintenance. The downhole CO2 displaces the oil through preferential adsorption of the CO2 in the sand/clay particles, although at higher temperatures this effect can be limited. Where the presence of nitrogen would unduly dilute associated natural gas, liquid oxygen could be used instead of air to supply the oxygen to the combustor. For very deep wells, the cost of compressing air can outweigh the cost of liquid oxygen production, leading to its preferential use independent of natural gas considerations. Using gaseous oxygen instead of air reduces the amount of oxidant which must be compressed. Rich catalytic combustion is used to produce hydrogen, which in the presence of injected catalyst ruptures heterocyclic bonds in heavy oils, improving mobility and transforming local non-mobile components into mobile (sweepable) oils, thereby improving sweep efficiency. The capability to control fluid pH enables control of clay permeability in clay-bearing strata, also important in improving sweep efficiency.

The catalytic combustor has two interrelated features that promote downhole combustion of hydrocarbon fuels for generation of both steam and hydrogen. Combustion stability does not require operation within normal flame stability limits. In addition, partial oxidation of fuel-oxidant mixtures under fuel rich conditions in the presence of steam allows production of high hydrogen content hydrogen-carbon dioxide-steam mixtures for in-situ hydrotreating.

In one embodiment, the present invention improves on catalytic combustion for downhole steam generation by operating the catalytic combustor sufficiently rich with sufficient steam to generate hydrogen with minimal production of carbon monoxide. Combining this operation with the optional injection of catalyst into the steam further promotes hydroviscbreaking of the heavy oil and allows control of pH. This approach retains all the benefits of downhole steam generation while adding the benefits of hydroviscbreaking and thereby significantly reducing costs and improving sweep efficiency.

In this embodiment of the present invention, the addition of water to the fuel suppresses soot formation, with data showing that substantial quantities of water (e.g. 4:1 water/fuel by weight) widens the range of soot-free operation. Typical partial oxidation and autothermal reforming produce carbon monoxide as well as hydrogen. To increase the amount of hydrogen produced, the reaction of carbon monoxide with steam (water) to produce additional hydrogen and carbon dioxide can be enhanced by increasing the water to oil ratio. Equilibrium calculations show that in high water content (e.g., 5:1 water/oil or higher), hydrogen production is greatly enhanced (e.g., @ 1400 F steam temperature for 8:1 water/oil, the hydrogen to CO ratio would be about 10:1).

Thus, a catalytic combustor of the present invention allows downhole generation of both steam and hydrogen at temperatures suitable for injection into an oil-bearing formation for viscbreaking of the heavy oil therein by hydrotreating. Suitable water/steam-soluble catalysts are available which can then be injected into the combustor's high temperature steam/effluent and thus into oil-bearing formations. Moreover, energy efficiency is improved since the heat of the hydroviscbreaking reaction is liberated at the point of reaction in the oil-bearing formation.

In another embodiment of the present invention, a hydrocarbon fuel and a gas containing oxygen having an equivalence ratio greater than two is combusted downhole in a catalytic partial oxidation (CPOX) reactor to produce heat and an admixture comprising carbon monoxide and hydrogen. Water may be injected into the hot combustion products to produce a cooled mixture containing sufficient steam for reaction with the carbon monoxide to produce hydrogen when contacted with a water gas shift catalyst. The cooled mixture may then be reacted in the presence of a water gas shift catalyst for production of additional hydrogen. Any autothermal or CPOX reaction system known in the art to produce hydrogen may be used in the present invention. Platinum group metal catalysts are preferred. Alternately, hot reaction products of partial oxidation may be recirculated to vaporize water added to the inlet feed stream for auto-thermal reforming.

This invention eliminates wellbore heat losses related to the steam injection line while improving sweep efficiency through hydroviscbreaking and improved downhole temperature control. At the same time, air pollutant emissions are reduced significantly. Downhole generation of steam using a catalytic combustor would economically outperform surface steam flooding for most depths and conditions even assuming excellent wellbore insulation. Since in-situ hydrotreating improves crude quality and rich operation of a catalytic combustor reduces the amount of air (or oxygen) required, the present invention significantly reduces the oil price required for profitability after extraction thus further augmenting the advantage compared to conventional steam flooding. The present invention effectively increases the recoverable reserves of heavy oils and also offers benefits in enhanced recovery of lighter oils and oil from shale.

This should thus prove beneficial to a wide range of oil production companies and, through market-pricing mechanisms, to the energy consuming public. Moreover, by effectively increasing U.S. oil reserves, this invention has the potential to reduce U.S. dependence on imported oil, and to offer a low-cost strategic oil reserve from wells too costly to produce at prevailing oil prices.

While the present invention has been described in considerable detail, other configurations exhibiting the characteristics taught herein for downhole catalytic combustion for hydrogen generation and heavy oil mobility enhancement are contemplated. Therefore, the spirit and scope of the invention should not be limited to the description of the preferred embodiments described herein.

1. A method of recovery of oil from an oil-bearing formation comprising:
a) providing a hot gas phase fuel-rich mixture of fuel, oxidant, and steam downhole, the mixture having a fuel-oxidant equivalence ratio of at least about two;
b) passing the mixture into contact with a catalyst suitable for auto-thermal reforming;
c) reacting the mixture to produce a product stream containing hydrogen; and
d) injecting the product stream into the oil-bearing formation.

2. The method of claim 1 wherein the ratio of steam to fuel of the mixture of step c is sufficiently high to yield a product steam having a carbon monoxide to carbon dioxide ratio less than 0.2.

3. The method of claim 2 wherein the ratio of carbon monoxide to carbon dioxide is less than 0.1.

4. The method of claim 1 comprising the additional step of producing the hot gas phase fuel-rich mixture by adding fuel and water to a mixture of the oxidant with a sufficient portion of the product stream to provide the heat required to vaporize sufficient water to provide the steam.

5. The method of claim 1 comprising the additional step of producing the hot gas phase fuel-rich mixture by combusting sufficient fuel in an oxidant stream to provide the heat required to vaporize sufficient water to provide the steam and mixing the heated oxidant stream with fuel and water.

6. The method of claim 1 comprising the additional step of mixing a fluid containing a hydrogenation catalyst with the product stream prior to injecting the product stream into the oil-bearing formation.

7. The method of claim 1 wherein the catalyst comprises rhodium.

8. A method for enhanced oil recovery comprising:
a) producing a hot product stream comprising steam and hydrogen by downhole fuel-rich combustion of a hydrocarbon fuel;
b) injecting the hot product stream into an oil-bearing formation at a temperature suitable for hydrotreating of the oil; and
c) producing hydrotreated oil from a production well.

9. The method of claim 8 comprising the additional step of mixing a fluid containing a hydrogenation catalyst with the product stream prior to injecting the product stream into the oil-bearing formation.

10. The method of claim 9 wherein the catalyst comprises boria.

11. The method of claim 9 wherein the catalyst comprises an alkali metal.

12. The method of claim 8 comprising the additional step of injecting water into the hot product stream to form a cooled stream with added steam.

13. The method of claim 12 wherein the cooled stream is contacted with a catalyst to promote the water gas shift reaction.

14. The method of claim 8 wherein at least a portion of the formation is heated to a temperature of at least 600 F.

15. The method of claim 8 wherein at least a portion of the formation is held at a selected temperature for at least five days.

16. A method for producing upgraded oil from an oil bearing formation comprising:
a) reacting a fuel and oxygen with a catalyst downhole to produce a heated product stream containing hydrogen and carbon oxides having temperature in excess of 600 F;
b) injecting the heated product stream into contact with an oil bearing formation;
c) continuing said injection for a period of time sufficient to heat at least a portion of the formation to a temperature of at least 600 F; and
d) producing upgraded oil from a production well.

17. The method of claim 16 wherein at least a portion of the formation is maintained at a temperature of at least 600 F for at least five days.
